(19) United States
(12) Patent Application Publication
(10) Pub. No.: US 2014/0129316 A1
(43) Pub. Date: May 8, 2014

(54) METHOD AND APPARATUS FOR ENABLING TARGETED ADVERTISING AND REWARDS BETWEEN CONSUMERS, BUSINESSES, AND DEVELOPERS

(71) Applicants: Robert Napoletano, Newtown Square, PA (US); Marco Napoletano, Springfield, PA (US)

(72) Inventors: Robert Napoletano, Newtown Square, PA (US); Marco Napoletano, Springfield, PA (US)

(21) Appl. No.: 13/840,125

(22) Filed: Mar. 15, 2013

Related U.S. Application Data
(60) Provisional application No. 61/722,416, filed on Nov. 5, 2012.

(51) Int. Cl. G06Q 30/02

(52) U.S. Cl. CPC G06Q 30/0207
USPC 705/14.36; 705/14.1

(57) ABSTRACT

Methods and apparatuses in which a multi-faceted network connects game developers, businesses (both product and service oriented), at times referred to as “retailer” or “retailers” and casual gamers, at times referred to as users/consumers through a series of interfaces for the mutual benefit of all involved is disclosed. Through the use of the interfaces described, a casual gamer has the incentive to keep playing developers' games in order to attain rewards based on their own preferences, therefore ramping up advertising revenues for the developer and issuing targeted coupons and promotions from a retailer to an engaged audience.

### CROSS REFERENCE TO RELATED APPLICATIONS

This application claims the benefit of U.S. Provisional Application No. 61/722,416 filed Nov. 5, 2012, the content of which is hereby incorporated by reference herein.

### BACKGROUND

With the increasing popularity of smartphones and mobile gaming, there is a need for new methods to generate advertising revenue for developers. Furthermore, methods are needed to create advertising revenue from the growing number of online consumers. There exists a need for interfaces that connect businesses with developers and consumers.

### SUMMARY

Methods and apparatuses in which a multi-faceted network connects game developers, businesses both product and service oriented businesses (hereinafter referred to as “retailer” or “retailers”), and casual gamers or consumers (hereinafter referred to as “users”) through a series of interfaces for the mutual benefit of all involved is disclosed. Through the use of the interfaces described, a casual gamer has the incentive to keep playing developers' games in order to attain rewards based on their own preferences, therefore ramping up advertising revenues for the developer and issuing targeted coupons and promotions (also referred to as rewards) from a retailer to an engaged audience.

### BRIEF DESCRIPTION OF THE DRAWINGS

A more detailed understanding may be had from the following description, given by way of example in conjunction with the accompanying drawings wherein:

FIG. 1 is a high level schematic of the Active Rewards (AR) system;

FIG. 2 is a diagram of the AR and User interface concerning initial signup;

FIG. 3 is a diagram of the AR and Developer interface concerning initial signup;

FIG. 4 is a diagram of the AR and Retailer interface concerning initial signup;

FIG. 5A is an AR swimlane diagram showing an example process flow for the AR system including the developer, the user, and AR; and

FIG. 5B is a continuation of the AR swimlane diagram in FIG. 5A including the retailer.

### DETAILED DESCRIPTION

Active Rewards (AR) is a multi-faceted network which may bring together game developers, both product and service oriented businesses (hereinafter referred to as “retailer” or “retailers”), and casual gamers or consumers (hereinafter referred to as “users”) through a series of interfaces for the mutual benefit of all involved. Through the use of the Active Rewards interface a user (casual gamer or consumer) may obtain the incentive to keep playing developers' games or using the developers' application in order to attain rewards (may also be referred to throughout as “award(s)”) based on their own preferences, therefore ramping up advertising revenues for the developer and issuing targeted coupons and promotions from a retailer to an engaged audience.

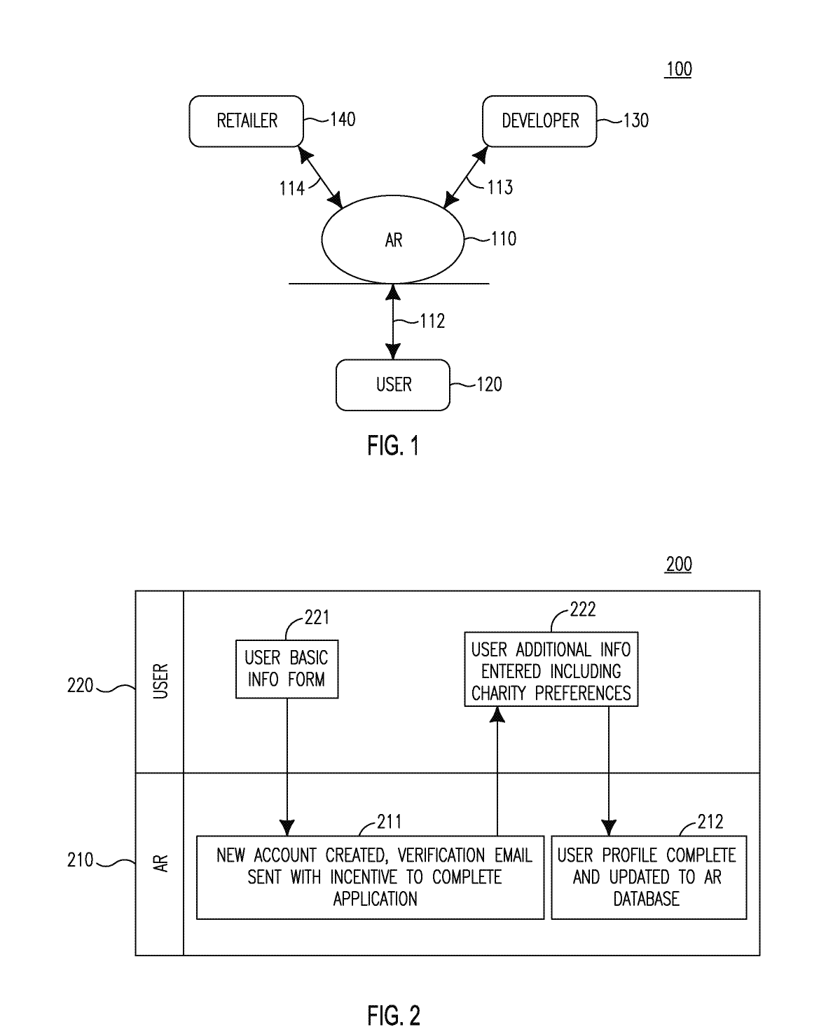

FIG. 1 is an example architecture of the Active Rewards (AR) network 100. The AR network 100 includes an interface 112 between AR 110 and the user 120 of the game/application. A user 120 may download a game/application that is already signed up with Active Rewards 110. A user 120 may refer to any game user (may also be referred to as a “gamer”), application user (may also be referred to as an “app user”), or consumer. The AR network 100 also may include an interface 114 between a retailer 140 and AR 110. The retailer 140 may include any business. The AR network 100 may also include an interface 113 between a game and application (may also be referred to as an “app,” “game/application,” or “game/app”) developer 130 and AR 110.

FIG. 2 is an example of a user account (may also be referred to throughout as “profile”) creation with Active Rewards (AR) 200 using the interface between a user 220 and AR 210. Before or during operation of the game/application there may be a sign in/up screen that pops up describing the optional active rewards program and may ask if a user is an existing member and would like to sign in or a new member and would like to sign up. If the user is not a member and would rather not sign up, or is a member and does not choose to sign in, then the game/application may start from level one.

In one embodiment, a code snippet in a game/application may allow AR 210 to send the user 220 a message asking the user 220 if they have an AR account 211 and providing the user basic information form 221 (may also be referred to throughout as a “survey”). The message may be displayed as a pop-up message, for example. In one example, the message box may have 2 button links. One of the button links may be associated with a “New User”. The selection of the “New User” button may prompt the user to create an account with AR and require the user to enter information into the user basic information form 221. The other button link may be associated with an “Existing User”. The selection of the “Existing User” button may prompt the user to log his existing account 211. Cookies may be configured so that user 220 may automatically be logged in next time the user plays or uses the same game/application. A link to “What is Active Rewards?” may also be displayed on the basic user form 221 or on an additional pop-up message, which may link the user 220 to more information. The user 220 may be presented with the information in a pop-up such that the user 220 is not taken away from playing the game or using the application.

When the user is a new member and decides to sign up and create an account, the user 220 may be sent to a user basic information form 221 where information given may include but is not limited to the following:

(1) First/Last name;

(2) Email address (email may also be the login ID);

(3) Password;

(4) Age/birthday (in one embodiment the user may be sent free rewards on birthday);

(5) Country/Geographical Location; and/or

(6) Interests chosen by the user may include but not limited to one or many of the following: sporting goods, fashion, electronics, beauty, pampering, health, donations, adventures, services, goods, restaurants, grocery etc. The user account may be stored with the user-specific information in the AR database 212.

AR 210 may create an account 211 using the user-specific information provided and also send a verification email to the user 220. The verification email may include an incentive to complete the application for the account 211, if it is incomplete. The user 220 may also enter additional user-specific information 222 including but not limited to charity preferences, which may also be stored in the AR database 212. The user 220 may be redirected back to the game/application at any time or following completion of user account creation.

If the user 220 decides not to login or register with AR, then the game may initiate in its normal sequence. However, if the user 220 already has an AR user account (through prior registration) the user 220 may log in. Once logged in, the developer may link this gaming instance with the user's 220 AR account 211. The periodic rewards provided through the AR interface may then be shown as reward notifications on the game/application at pre-determined times either in between shots such as if it is a shooting game, for example, or after levels if it is an action game, for example, as to not disturb the gamer/user during important moments of the game/application. AR 210 may suggest to game/application developers certain milestones to be reached in order to activate/send rewards from third party retailers. The amount of the rewards may be tiered in amount in accordance with the level a user reaches on a certain game/application. The pre-determined preferences of the user may dictate the type of reward provided by consistently updating reward database. The database used to match preferences from the retailer and user may be referred to as the Active Rewards Selection Matrix. Any reward earned by the user may then be deposited into the user AR account 211.

According to one embodiment, the reward offers may be tailored to the individual users 220 based upon the short user survey that may be filled out prior to starting the game if the user 220 is a new user. Alternatively, the rewards offers may be tailored to the individual user based on the information entered on the user basic information form 221 when the gamer/user initially signed up.

All earned rewards may be deposited in the user's account 211. As the user 220 continues playing games, AR 210 may learn the type of rewards that the user 220 most enjoys and further tailor its offerings according to those preferences. At any time, the user 220 may adjust the user preferences and information by accessing the user-specific information 222 and choosing different reward types and/or specific products, services, or preferences, in which the user 220 may be interested. The rewards offered may then be updated in the AR database 212 accordingly.

On each individual game/application with which AR 210 partners, there may be times in the game/application when the AR 210 program shows reward notifications or updates on the screen. These notifications or updates may be shown in between levels on action games or in between important events/sequences/accomplishments, etc., in which the offered reward may be identified. The user 220 may then realize the reward associated with their next event or level completion.

For example, a user 220 may be offered a coupon at an electronics store if the user 220 accomplishes a particular objective in a game, such as completing an event or completing a level. Accordingly, the user may be provided incentives to continue playing the game or operating the application. In another example, a user 220 may be offered a free 10 minute massage at a local spa if that user 220 completes the next level in less than 60 seconds. In yet another example, a user 220 may earn free toppings on their next pizza order if the user 220 is able to beat the level being played.

An AR user 220 may manage all of their earned rewards by logging into the account 211 associated with the user 220 through AR 210. AR 210 may be accessible through a website, network, or via the AR's 210 mobile application. AR users 220 may redeem earned rewards through a mobile application by means of QR code or by printing the earned rewards directly from their account 211. Further, a user may simply visit the brick and mortar store in which the user 220 has a reward and either print or show the QR code on their phone to the retailer in order to redeem the earned rewards. Alternatively or additionally, a user 220 may visit a website and enter in a rewards code in order to redeem the earned rewards.

An AR user 220 may select retailers in the AR database 212 from which to earn rewards. In one example, the AR database 212 may include regional stores in the vicinity of the user's 220 location attained through unlocking the GPS location of the AR user 220 phone.

After a user 220 has accepted a coupon or reward, the coupon or reward may be deposited into the user account 211 automatically. Each reward may have an expiration date associated with it as applicable by law. The user 220, at any time prior to the expiration date of the reward, may have the ability to gift, trade, or transfer the reward/coupon to a friend (expiration date may not change) or donate the coupon/reward (AR 210 may donate a portion of their profit received from advertisement/membership revenue) to the charity of the user's 220 choice.

Additional applications of the interface between AR 210 and a user 220 are described below in accordance with other embodiments:

In one example, AR 210 may work with users 220 to accomplish fitness goals that are difficult to attain. The rewards may be significant such as earning free gasoline for a month or 10 free gasoline fill ups. Active Rewards may also link up with healthcare providers, because all participants may begin exercising in measurable amounts. Exercise may be measured via a pedometer device or other fitness devices and apparatuses that measure parameters including but not limited to calories, heart rate, duration, distance, and/or weight in combination with an application, such as Wii fit for example. Recorded data pertaining to the exercise may be uploaded to healthcare providers and also to gasoline companies for example. The gasoline prices may be paid for through a combination of funds from the gasoline company itself and also the healthcare providers according to the amount of people they subscribe that participated in the contest. These healthcare companies may get their benefit because now their subscribers are healthier, even if they didn't win the free gasoline. This may lower claims that the healthcare companies need to pay for and thus save money.

In yet another embodiment, AR 210 may offer periodically, for example every month or quarter, a sizable reward through a contest on the AR application. This reward may be for example a house or a fancy car. The buzz generated from this promotion may cause large numbers of users 220 to download a certain game and play as many times as possible in the contest allotted timeframe to win the house or fancy car or other sizable reward. This may generate a significant number of downloads and advertising revenue for the game or application developer as well as free advertising for the donating car company or home builder, hopefully enough to pay for the prize.

In another example, the user 220 may be offered a new car for having the highest score in a particular month for a particular game.

These aspects of AR 210 may also be used to launch new games/applications due to its viral marketing potential by offering such a significant reward. Once the game/application is downloaded by the user 210 to use in the contest, there is a strong likelihood that the user 210 may keep the game/application on their device including but not limited to smartphone, computer, or gaming system and access it periodically generating advertising revenue for the developer.

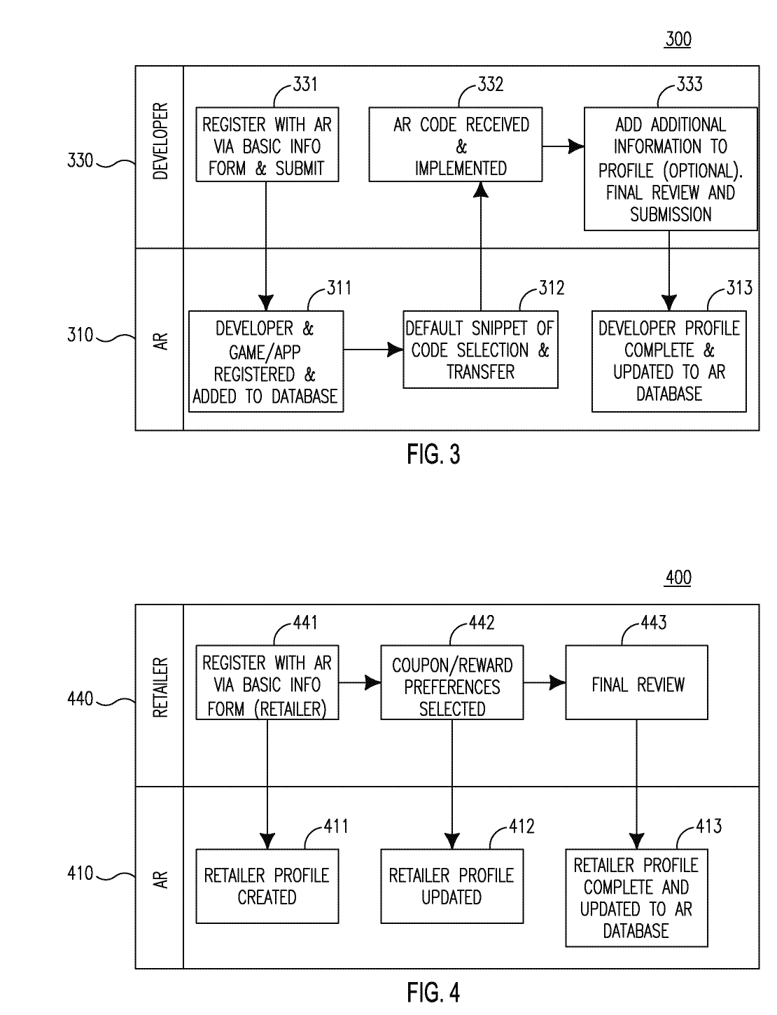

FIG. 3 is an example of developer registration with Active Rewards (AR) 300 using the interface between a game and application (game/application) developer 330 and AR 310. The game/application developer 330 may be introduced to and invited to register with AR 310 via a welcome screen providing an overview of how the program works and a basic information form 331. This basic information form 331 may also include instructions on how to add the AR snippet of code to the developer's 330 game/application and the suggested areas of the game/application code to add the AR snippet of code in order to enable the interaction and interface with AR to deliver retailers' coupons to the user. Once the developer 330 has registered via the basic information form 331, the developer and the game/application account 311 is registered and added to the AR database 313. A default snippet of code 312 may be selected and transferred from AR 310 to the developer 330. The developer 330 may receive an AR snippet of code and implement the AR code within the game/application 332. A developer 330 may also review and add 333 additional information to the developer and the game/application account 311 and the updated/reviewed developer and the game/application account 311 may be submitted to AR to be stored in the database. AR 310 may then receive the developer and the game/application account 311 and store it in the AR database 313.

The AR 310 interface with game/application developers 330 includes but is not limited to games and applications via mobile application programs/platforms such as Android, iOS, Windows and Blackberry; web enabled Game consoles such as Sony Playstation, Microsoft Xbox, Nintendo Wii, etc; and web application programs/platforms including applications played on Facebook and other sites.

The interface between AR and Retailer is described below in accordance with one possible embodiment:

FIG. 4 is an example of retailer registration with Active Rewards (AR) 400 using the interface between a retailer 440 and AR 410. AR 410 may sign up retailers 440 that may offer certain rewards based upon their own marketing objectives.

Retailers 440 may be introduced to AR and invited to register and create an account 441 via a welcome screen with an overview of how the program works as well as instructions for topics including but not limited to choosing desirable ads and marketing those ads to users. The retailer 440 may be provided a basic user information 441 form or survey as well. The retailer 440 may complete the basic information form 441 with retailer-specific information and submit it to AR 410 so that AR may create a retailer account 441 and store the retailer-specific information in the AR database 413.

In accordance with one embodiment, a retailer may click on a “Getting Started” button that may bring the retailer a marketing/ad/coupon/reward preferences 442 screen. The retailer 440 may then be able to access information regarding What, Who, When, Where and How the ad/coupon/reward may be handled. The retailer 440 may then configure marketing/ad/coupon/reward details such as the % of price discount or $ amount discount as well as the ad/coupon/reward text options. There may also be a number of pre-determined discounts offered in order to streamline the process of issuing a reward for a retailer. During this process, the retailer 440 may save the marketing/ad/coupon/reward configuration preferences to update the retailer account 412 with AR. The complete retailer account 412 may be saved and stored in the AR database 413 and accessed by the Active Rewards Selection Matrix.

The retailer 440 may also review their account selections and preferences and submit 443 the complete account to AR. The complete retailer account may be saved and updated in the AR database 413 and accessed by the Active Rewards Selection Matrix.

In one embodiment, the process detailed above may include the following steps for enabling a retailer's use of AR:

(1): Ad/reward Preferences:

(a) What—Product/Service being advertised/discounted

(b) Who—Demographic(s) to be targeted

(c) When—Frequency or preferred time of ad delivery

(d) Where—Geographical location of ad delivery

(e) How—Mobile (Android, iOS, MS Windows, Blackberry), Console (SP, Wii, Xbox), Web (internet)

(2): Ad/reward Selection

(a) % of price discount

(b) $ reduction on purchases over $

(c) Select Ad/Coupon text

(3): Review

(a) Review selections

(b) Submit

Retailers 440 may have the ability to tailor any attribute of the rewards such as the rewards' accessibility as much as they prefer. Retailers 440 may be able to choose between certain demographics to where/whom the rewards may be offered. A questionnaire may be used to allow the retailer to limit the offerings to being as general as every member of AR 410 or as specifically as possible. A retailer 440 may also choose the length of time in which the reward is active for in order to create a sense of urgency with the rewarded gamer to visit retailer on a timely basis.

If rewards are attained, then the reward may be deposited into the user's A/R account. Conditions of the reward may be shown very conspicuously, and a countdown clock may be created so a user always knows how long they have to redeem an offer. The reward may be accessible by means of QR code, which can be read by simple QR readers at retailer's brick and mortar store. If QR readers are not in use, there may be text versions also available. Retailers may be sent periodic updates verifying rewards issued for accountability purposes.

Retailers may be charged a tiered amount depending on whether or not the reward is offered, won, accepted, and finally used.

Charities may sign up with AR 410 using the same or similar method detailed above that any retailer may use in order to benefit from this program. AR may also work with necessity based companies to offer significant rewards in accordance with another embodiment.

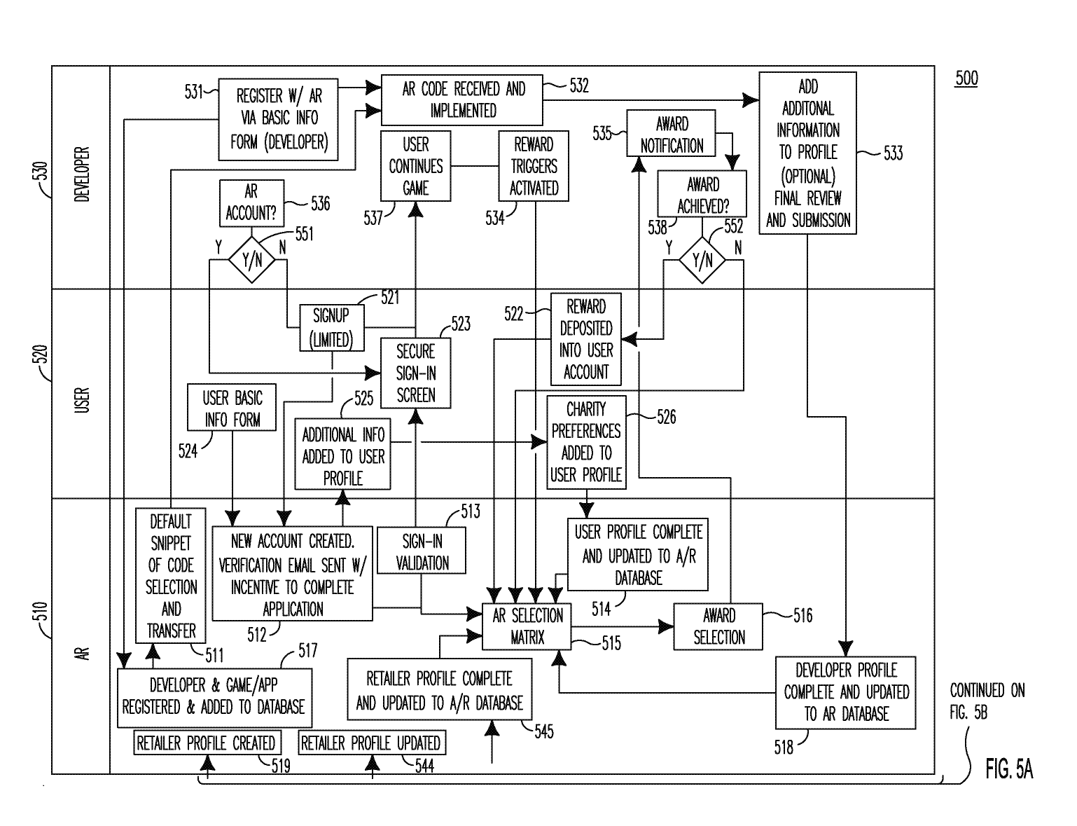

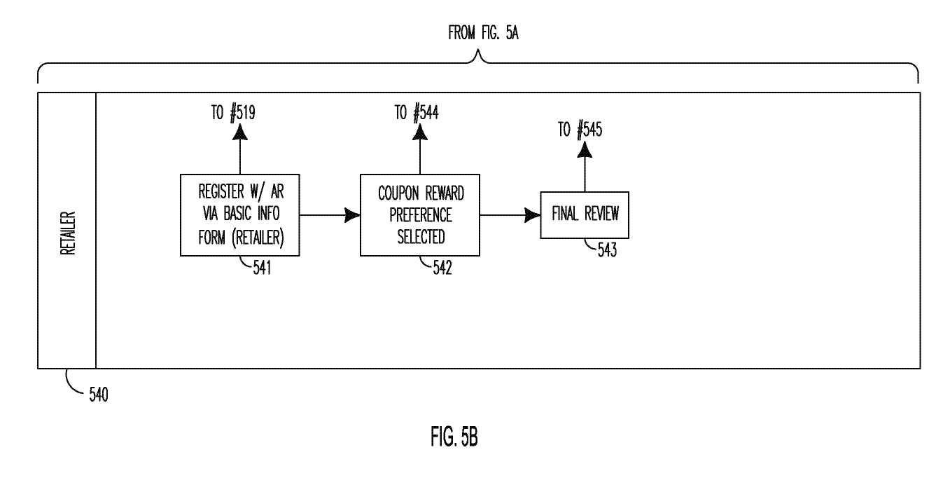

FIGS. 5A-5B detail an example process flow through the AR network 500 and the interaction among AR 510, a user 520, a developer 530, and a retailer 540. The user 520 may complete a basic user form 524 for AR 510 which then creates a new account and may send an automatic email confirming the account application is complete or providing an incentive to complete the application 512. AR also provides sign-in validation 513 for the user 520 via a secure sign-in screen 523. Account creation 512 and sign-in validation 513 are saved in the Active Rewards Selection Matrix 515, which is the database used to match preferences from the retailer 540 and user 520 based on user-specific information and retailer-specific information. The user 520 may add additional information to the user account 525, such as adding charity preferences 526 to the user account, and then those updates are also stored in the user account in the AR database 514, which are then saved in the Active Rewards Selection Matrix 515.

Retailers 540 register with AR via a basic information form 541, which creates a retailer account 519 within AR. The registered retailer 540 may update marketing/ad/coupon/reward preferences 542 and save them to the AR retailer account 544. The retailer 540 may review and submit 543 a complete retailer account application, which may be stored in the AR database 545 and stored in the Active Rewards Selection Matrix 515.

Developers 530 may register for a developer account with AR via a basic information form 531, which AR may store into its database as a registered developer and registered game/application 517 provided by the developer. Following developer and their associated game/application registration, a default snippet of code is selected and transferred 511 to the developer. The developer 530 may then receive the AR code and implement the AR code 532 within the game/application. The developer 530 may also add additional information to their account at any time and also review and submit their account 533, which may be stored in the AR database 518 and saved in the Active Rewards Selection Matrix 515.

During game/application operation, a user 520 may be asked whether or not 551 the user 520 has an AR account 536. If the user 520 does not have an AR account, the user may be provided the opportunity to create an account 521 using the same process of new account creation 512 described above. If the user 520 has an AR account, the user continues the game 537 which then activates reward triggers 534 in the Active Rewards Selection Matrix 515. The Active Rewards selection Matrix 515 then automatically selects a reward 516 from its database according to the cross-matched preferences of the user 520 and retailer 540. This selection of the reward 516 may occur during operation of the game/application or at another point such as following completion of the game or exiting of the application. After selection of the reward 516 during game/application operation, a reward notification 535 is received by the game/application of the developer. The developer's game/application determines if the reward is achieved 538. The reward may or may not be achieved 552 during game/application operation. If the reward is achieved, a reward is then deposited 522 in the user account and the Active Rewards Selection Matrix 515 is updated with the user's reward achievement. If the reward is not achieved, the Active Rewards Selection Matrix 515 is also updated with that status.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

In addition, the methods described herein may be implemented in a user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

In addition, the methods described herein may be implemented in a processor. The processor may further be coupled to other peripherals, which may include one or more software and/or hardware modules that provide additional features, functionality and/or wired or wireless connectivity. For example, the peripherals may include an e-compass, a pedometer, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

What is claimed is:

1. A method for providing rewards to a user, the method comprising:
creating an account for the user, wherein an account is created for each user and each account contains user-specific information;
storing each user account in a database;
creating an account for one or more retailers, wherein an account is created for each retailer and each account contains retailer-specific information and marketing preferences;
storing each retailer account in the database; and
providing rewards to the user based on the accounts stored in the database while the user is playing a game or application, wherein the rewards are provided to the user based on the information stored in the user account and the one or more retailer accounts.

2. The method of claim 1 wherein the user account is created in a game or application in response to a sign in or sign up screen.

3. The method of claim 1 wherein the user-specific information is entered in a user survey.

4. The method of claim 1 wherein the rewards provide the user incentives to continue operation of the game or application in order to earn the rewards.

5. The method of claim 1 wherein the rewards are deals or discounts with the retailer.

6. The method of claim 1 further comprising:
depositing the rewards directly into the user account.

7. The method of claim 1 further comprising:
matching, by a selection matrix, preferences based on the user-specific information and preferences based on the retailer-specific information stored in the database; and
providing rewards to the user based on the matched preferences.

8. The method of claim 1 wherein the retailer account contains one or more products, services, deals, or discounts that are provided as rewards to the user.

9. The method of claim 1 wherein the marketing preferences are entered in a retailer survey.

10. The method of claim 9 further comprising:
displaying rewards based on the marketing preferences associated with the retailer survey.

11. The method of claim 1 wherein the rewards are targeted to the user based on the user-specific information in the user account and the retailer-specific information in the retailer account.

12. The method of claim 1 further comprising:
providing a pop-up message during operation of the game or application, wherein the pop-up message contains an interface that enables the user to enter the user-specific information and store the user-specific information in the user account.

13. One or more non-transitory computer readable media storing a set of instructions for execution by one or more processors, the set of instructions comprising:
a first creating code segment for creating an account for a user, wherein an account is created for each user and each account contains user-specific information;
a first storing code segment for storing each user account in a database;
a second creating code segment for creating an account for one or more retailers, wherein an account is created for each retailer and each account contains retailer-specific information and marketing preferences;
a second storing code segment for storing each retailer account in the database; and
a providing code segment for providing, to the user, reward notifications based on the accounts stored in the database while the user is playing a game or application, wherein the reward notifications are provided to the user based on the information stored in the user account and the one or more retailer accounts.

14. The one or more non-transitory computer readable media of claim 13 wherein the user account is created in the game or application in response to a sign in or sign up screen.

15. The one or more non-transitory computer readable media of claim 13 wherein the user-specific information is entered in a user survey.

16. The one or more non-transitory computer readable media of claim 13 further comprising:
a matching code segment for matching, by a selection matrix, preferences based on the user-specific information and preferences based on the retailer-specific information stored in the database; and
a providing code segment for providing rewards to the user based on the matched preferences.

17. A user equipment (UE) configured for providing a user interface for providing rewards to a user during operation of a game or application, comprising:
a receiver configured to receive a user basic information form for a user account from a network;
an interface configured to display the user account to the user, wherein the user account is created for the user and contains user-specific information;
a transmitter configured to transmit the user-specific information to the network;
the receiver configured to receive reward notifications from the network, wherein the reward notifications are based on the user account and one or more retailer accounts stored at the network; and
an interface configured to display the rewards notifications to the user while the user is playing a game or application.

18. The UE of claim 17 wherein the user basic information form is displayed as a sign in or sign up screen.

19. The UE of claim 17 wherein the user-specific information is entered in a user survey.

20. The UE of claim 17 wherein the reward notifications are matched, by a selection matrix, based on the user-specific information and preferences based on retailer-specific information.
